(19) United States
(12) Patent Application Publication
(10) Pub. No.: US 2014/0313377 A1
(43) Pub. Date: Oct. 23, 2014

(54) IN RELATION TO A LENS SYSTEM FOR A CAMERA

(71) Applicant: Mark Ross HAMPTON, Swanson, Auckland (NZ)

(72) Inventor: Mark Ross Hampton, Auckland (NZ)

(21) Appl. No.: 14/357,405

(22) PCT Filed: Nov. 8, 2012
(86) PCT No.: PCT/NZ2012/000206

§ 371 Date: May 9, 2014

(30) Foreign Application Priority Data
Nov. 9, 2011 (NZ) 596294

(51) Int. Cl. G02B 17/08; H04N 5/262; G06T 5/00

(52) U.S. Cl. CPC G02B 17/08; G06T 5/001; H04N 5/2628
USPC 348/241; 359/736; 359/737

(57) ABSTRACT

Disclosed is a lens system for removable connection to a portable programmable device which includes a camera. This lens system can be arranged in various embodiments to modify the field of view experienced by this camera, and in specific embodiments can modify the direction of this cameras field of view. The device can also be used to provide software capable of executing on a portable programmable device, in addition to providing a light pipe to redirects light used as a photographic flash in applications where it modifies the direction of view of a camera.

### TECHNICAL FIELD

This invention relates to improvements in and in relation to lens system for a camera. In particular embodiments, the invention can provide a lens system for a camera which changes the direction of the field of view of the camera.

The invention may be particularly suitable for attachment to, or incorporation within, portable programmable devices devices that include a camera, such as for example, mobile phones, smartphones, laptops, and mobile computers or electronic tablets such as iPads®.

However, it is to be understood and appreciated that the invention may also have other applications and/or uses. The prior art and possible applications of the invention, as discussed below, are therefore given by way of example only.

### BACKGROUND ART

Digital cameras are well known. Many electronic devices also typically include digital cameras, for example mobile electronic devices such as mobile phones and electronic tablets.

When using a digital camera, including a digital camera incorporated in such electronic devices, the user typically orients the camera towards the scene to be photographed. The user may then look through a view finder or at a screen to see the scene that will be photographed.

Typically the view finder or display of the camera is aligned with the optical axis of the camera. So the orientation of the photographer's regard also usually indicates the orientation of the camera.

Anybody observing the photographer, including people in the scene, will usually be aware of the orientation of the camera, and hence will be aware of what or who the photographer is trying to photograph. A disadvantage of this is that the attention of people in the scene may be drawn to the camera and this may distract them from the activity they are engaged.

Furthermore, in some instances, the photographer may wish to take a photograph of a scene without the people noticing, for example in order to capture natural and uninhibited shots of people, as is the case with street photography. This may be difficult to achieve if the people in the scene are aware of the orientation of the camera, and as a result, they may end up posing or looking into the camera, or alternatively they may become self-conscious and attempt to hide from the camera.

Hence, if people in the scene notice that the photographer is looking away from them, then they will not pose for, or hide from, the camera, and furthermore they are less likely to be distracted from the activity they are engaged in.

Improvements over the prior art which allowed the direction of view of the camera to be redirected would be particularly useful when high or low angle shots are to be recorded. However the majority of existing camera systems cause difficulties for a user when they wish to frame high or low angle shots. In the case of low angle shots where the camera is located close to the ground, a user effectively needs to lie on the ground to properly view cameras display screen. A similar issue is present in respect of high angle shots where the camera is to be positioned high above a user's head, preventing a user from easily viewing the cameras display screen to effectively frame the shot.

There are several devices on the market that permit the photographer to orient their view in a different direction from a camera's field of view.

A right angle spy lens for digital cameras is a lens attachment that will allow the photographer to shoot directly to the left or right of where the camera appears to be pointing. However, this product is only available for cameras with lens threads of 52 mm, 55 mm and 58 mm—which are typical sizes for DSLR cameras. Hence, a disadvantage of this product is that it is not able to be used for cameras that lack a lens thread, for example those found on mobile phones or electronic tablets.

A device using a mirror for changing the angle of the field of view is disclosed in United Kingdom Pat. No. GB 2,394,552. However, this product is also not suitable for the small cameras found on most mobile electronic devices as these cameras typically lack a lens thread. Furthermore, the devices described in GB 2,394,552 are large relative to the size of the camera, and hence they cannot generally be used with most mobile electronic devices.

Furthermore, the solution presented in United Kingdom Pat. No. 2,394,552 allows a single lens camera to see in more than one direction. By inserting two mirrors into the camera's field of view a single image can include a partial view of the field to the left, directly in front and to the right of the camera's optical axis. The resulting image is very different from a normal camera image which uses a single direction for the field of view. Furthermore, the angle of view in each direction is restricted because the camera's original angle of view is shared by three different fields.

Some mobile devices, particularly digital cameras, have tilt and swivel screens which allow the scene to be viewed at an angle that is different from the optical axis of the camera. However, a disadvantage of tilt screens is that the tilt screen requires the mobile device to be designed with this in mind, and adds complexity and cost to the manufacturing of the mobile device.

Some mobile devices, particularly mobile phones and tablet computers, have a tilting camera that allows the optical axis of the camera to be modified relative to the screen of the mobile device. An example of such a tilting camera for a mobile phone is disclosed in U.S. Pat. No. 7,133,691. However, a disadvantage of such tilting cameras is that they only modify the inclination of the camera and do not provide the camera with the ability to take photos to the left or right relative to the original direction of the camera's field of view.

There are also products available for taking 360 degree videos using a mobile phone. However, these attachments can be relatively large compared to the mobile device. They also reduce the resolution of the image to a point where they are not well suited to taking still images.

Mobile phones and other similar forms of portable programmable devices commonly include cameras and are popular with the general public. These devices are conveniently on hand at most times when a user may wish to take a photograph. However the cameras provided in these devices do not incorporate high-quality optical elements and are not optimised or specifically adapted for photographic applications.

An important characteristic of these devices is their portable nature. These devices are designed to be as small as possible to ensure they can be carried almost anywhere and employed at the convenience of the user. This characteristic also requires any additional accessory component use with these devices to also have its size kept to a minimum.

A number of different types of portable programmable devices also include a light source capable of functioning as a flash for any camera incorporated into the device. However these light sources can only function as a flash when a photograph is taken along the same optical axis as the camera provided.

### OBJECT

It is an object of the present invention to provide improvements in respect of a lens system for a camera which goes some way towards addressing one or more of the above problems or difficulties, or which at the very least provides the public with a useful choice.

### DEFINITIONS

Throughout this specification unless the text requires otherwise, the word ‘comprise’ and variations such as ‘comprising’ or ‘comprises’ will be understood to imply the inclusion of a stated integer or step or group of integers or steps but not the exclusion of any other integer or step or group of integers or steps.

### STATEMENTS OF INVENTION

According to one aspect of the present invention there is provided a lens system for a camera, the lens system including a housing attached, or attachable, to the camera, the housing including an optical system which is adapted to change the field of view of the camera.

According to another aspect of the present invention there is provided a lens system for a camera, substantially as described above, wherein the lens system further includes a software application adapted to manipulate and/or improve an image captured by the camera.

According to another aspect of the present invention there is provided a lens system for a camera, substantially as described above, wherein the camera is a digital camera.

According to an alternative aspect of the present invention there is provided a lens system for a camera, substantially as described above, wherein the camera is incorporated within a portable programmable device or mobile electronic device.

According to another aspect of the present invention there is provided a lens system for a camera, substantially as described above, wherein the optical system includes an optical element such as a reflective element.

According to another aspect of the present invention there is provided a lens system for a camera, substantially as described above, wherein the optical system includes an optical lens or lenses.

According to a further aspect of the invention there is provided a lens system adapted for removable connection to a portable programmable device which includes a camera, the lens system including

an optical system arranged to re-direct by a desired angle the direction of view of the camera of a portable programmable device to which the lens system is attached, the optical system including a reflective element for changing the direction of view of the camera, and an objective lens assembly, and

a housing for said optical system, said housing arranged to locate the optical system in alignment with the camera of a portable programmable device

wherein the housing positions optical systems reflective element between the objective lens assembly and the camera.

In some embodiments the objective lens assembly of the optical system implements a wide angle lens.

In some embodiments the objective lens assembly of the optical system implements a fish eye lens.

In some embodiments the objective lens assembly of the optical system implements a zoom lens.

In some embodiments the objective lens assembly of the optical system implements a macro lens.

Preferably the optical system includes a convergent lens assembly.

In some embodiments a convergent lens assembly is at least in part provided by the objective lens assembly.

In some embodiments a convergent lens assembly is positioned by the housing between the reflective element and the camera.

According to another aspect of the present invention there is provided a lens system for a camera, substantially as described above, wherein one or more optical lenses may be inserted between the camera lens window and the reflective optical element.

According to another aspect of the present invention there is provided a lens system for a camera, substantially as described above, wherein the optical system is based on a Galilean telescope.

According to another aspect of the present invention there is provided a lens system for a camera, substantially as described above, wherein the optical system is based on a Keplerian telescope.

According to a further aspect of the invention there is provided a method of image capture and modification implemented through the execution of computer readable instructions configured to execute on a portable programmable device which includes a camera system, said camera system being associated with a removable lens system, said instructions arranged to execute the steps of

i. receiving an input image from the camera system captured using the lens system, and

ii. applying at least one correction function to the input image, and

iii. outputting at least one corrected image,

wherein said correction function is adapted to improve the quality of the image captured by the camera.

According to a further aspect of the present invention there is provided a method of image capture and modification substantially as described above, characterized by the additional preliminary step of identifying the portable programmable device and/or camera system.

According to another aspect of the present invention there is provided a method of image capture and modification, substantially as described above, wherein the computer readable instructions are provided as a software application installed in the portable programmable device which incorporates the camera.

According to another aspect of the present invention there is provided a method of image capture and modification, substantially as described above, wherein the software application is adapted to manipulate, and/or improve the quality of, the image captured by the camera by applying digital signal processing algorithms to the image.

According to another aspect of the present invention there is provided a method of image capture and modification, substantially as described above, wherein the software application is adapted to reduce the impact of optical aberrations and/or improve the perceived image quality.

According to another aspect of the present invention there is provided a method of image capture and modification, substantially as described above, wherein the software application is adapted to correct for any geometrical distortions.

According to another aspect of the present invention there is provided a method of image capture and modification, substantially as described above, wherein the software application is adapted to correct for mirroring or inversion of the scene to be photographed.

According to another aspect of the present invention there is provided a method of image capture and modification, substantially as described above, wherein the lens system further provides for a flash associated with the camera to be re-oriented in the modified direction of the field of view.

According to another aspect of the present invention there is provided a method of image capture and modification, substantially as described above, wherein the software application is further adapted to maintain an angle of view for the camera that is typical, when the lens system is used to change the direction of the field of view.

According to a further aspect of the invention there is provided a computer readable medium bearing computer readable instructions for a portable programmable device, said instructions being arranged to execute on a portable programmable device which includes a camera system, said camera system being associated with a removable lens system, the instructions arranged to execute the steps of
receiving an input image from the camera system captured using the lens system, and
applying at least one correction function to the input image, and
outputting at least one corrected image,

wherein said correction function is adapted to improve the quality of the image captured by the camera.

Preferably said computer readable instructions include the additional preliminary step of identifying the portable programmable device and/or camera system.

Preferably said computer readable instructions execute the additional steps of
receiving at least one input orientation indication from one or more orientation sensors associated with the programmable device
applying at least one translation function to an input image
generating a cropped image by selecting a sub-region of a translated image
outputting said cropped image

wherein an input parameter of said translation function is the orientation indication received from an orientation indication sensor.

According to a further aspect of the invention there is provided a lens system adapted for removable connection to a portable programmable device which includes a camera, the portable programmable device including a light source located adjacent to said camera, the lens system including

an optical system, and

a housing for said optical system, said housing arranged to locate the optical system in alignment with the camera of a portable programmable device, and

at least one light pipe, wherein the light pipe includes
a body which provides an optical waveguide, and
an inlet arranged to receive light into the body, and
at least one outlet arranged to emit light from the body

According to yet another aspect of the invention there is provided a light pipe for a lens system, the lens system being adapted for removable connection to a portable programmable device which includes a camera, the portable programmable device including a light source located adjacent to said camera, wherein the light pipe includes

a body which provides an optical waveguide, and

an inlet arranged to receive light into the body, and

at least one outlet arranged to emit light from the body

wherein the inlet and said at least one outlet are orientated at an angle to each other.

The present invention is adapted for use with a camera incorporated within a portable programmable device such as, for example, a mobile phone, a smartphone, laptop computer, mobile computer or electronic tablet. These types of programmable mobile electronic devices may be referred to in general throughout this specification as a camera or the camera which the invention is used in combination with.

Reference in general throughout this specification will also be made to the invention being used with a portable programmable device provided by a smart phone. However those skilled in the art will appreciate that a range of other alternative multiple use portable programmable devices which incorporate cameras may also be employed in conjunction with the invention.

Reference in general throughout this specification will also be made to the invention being used to provide improvements with respect to the recording of images, and still photography in particular. However those skilled in the art should readily appreciate that the various aspects of the invention perform equally well in providing improvements in respect of the recording a sequence of images to provide a video recording. References to an image throughout this specification should be interpreted as encompassing both still photography and also video photography.

Reference throughout this specification will also be made to a smart phone or other similar device incorporating a camera in addition to either or both of a light source capable of providing a flash function for the camera, and/or one or more orientation sensors providing an orientation indication for the camera, smart phone or similar device. These forms of light sources are normally oriented to emit white light towards the same direction faced by the optical axis of the camera, while an orientation sensor can be provided by one or more accelerometers able to detect and also measure tilting or angling of the smart phone. Again however those skilled in the art will readily appreciate that the present invention may be arranged for use with other forms of smart phone or other similar devices which need not necessarily incorporate such light sources or orientation sensors.

References throughout the specification will also be made to a camera having a direction of view which is determined by or in line with the optical active axis of the camera. In some embodiments this direction of view of the camera may be re-directed to change the field of view captured by the camera when a photograph is recorded. In such cases the invention can provide a lens system, where the direction of view of the camera is modified to be that of the direction faced by the lens system when connected to the camera. The field of view—being the extent of the scene captured by light-sensitive elements of the camera—may also in some additional embodiments be modified from that normally captured by the camera in isolation from a lens system provided by the invention.

In a range of embodiments enabled by the invention a cameras field of view may be modified and the cameras direction of view may also be redirected. In other embodiments the field of view of a camera may remain unchanged and the direction of view may be redirected, while in yet other embodiments the invention may be employed to modify the cameras field of view and leave the direction of view unchanged.

Those skilled in the art will also appreciate that the present invention incorporates provides a number of different aspects which may be provided in a range of combinations in various embodiments. In various instances different aspects of the invention may be provided in isolation from one another while still remaining within the scope of the invention. In particular, one aspect of the present invention provides a lens system which may be arranged in some cases to modify the direction of view of the camera and in yet other embodiments modify the field of view of the camera. In another aspect the present invention provides computer executable instructions, software and/or an App arranged to implement a method of image capture and manipulation. In yet another aspect the invention may provide a light pipe preferably used to redirect the light of the camera flash.

In a preferred embodiment, the housing may be attachable to the camera, preferably being releasably attachable. In a range of embodiments the housing is used to align the optical system of a lens system with the camera, while allowing the lens system to be removed from the camera when not in use.

In some embodiments the housing includes a self-adhesive backing material applied to an exterior surface of the housing.

In some embodiments the housing includes a polyurethane gel sheet backing material applied to an exterior surface of the housing.

In some embodiments the housing includes a magnet which forms or which is located adjacent to an exterior surface of the housing.

In yet other embodiments the housing is formed by a case that grips all or part of the portable programmable device. For example, in such embodiments the housing may be attached to the camera using a case that grips all or part of the camera.

As indicated above, a further aspect of the invention provides a lens system. This lens system includes an optical system located by a housing.

The housing of a lens system may in a range of embodiments include an optical system for changing the direction or the field of view of the camera. For example, in some embodiments the optical system may include a reflective optical element, for example a mirror or prism, for changing the direction view of the camera.

In a further preferred embodiment a reflective element of the optical system may be formed by a prism. Prisms are formed from materials with a higher reflective index than air, allowing a prism to form a more compact component than a mirror used to form a reflective element.

In one particular embodiment the invention may provide a lens system which includes the optical system arranged to redirect the direction of view of the camera by a substantially 90 degree angle.

However, those skilled in the art may also appreciate that in other embodiments a lens system provided by the invention may not necessarily be arranged to redirect the direction of view of a camera. For example in other embodiments a lens system provided by the invention may for example be used to modify the field of view only of the camera—potentially by modifying the extent or characteristics of the cameras field of view.

Reference in general throughout this specification will however be made to the present invention being used to re-direct or modify a cameras direction of view. However those skilled in the art will appreciate that a lens system provided by the invention may alternatively be used in isolation to modify a cameras field of view if required.

To use a large portion of the camera's default field of view while reducing the size of the housing, an optical lens, or optical lenses, may preferably be included in the housing. Preferably, one or more lenses may be inserted between the camera lens window and a reflective optical element. One or more lenses may be also, (or alternatively) be inserted after the reflective optical element.

Reference throughout this specification will also be made to a lens system being provided with one or more lens assemblies. Those skilled in the art will appreciate that a lens assembly may be formed from a single integral lens element, or a group of lenses located next to one another with no additional optical components separating the lenses of the group.

In a preferred embodiment a lens system provided by the invention includes an objective lens assembly. The lens system may be arranged so that an objective lens assembly sandwiches or positions any reflective optical element between it and the camera. In a variety of embodiments an objective lens assembly will therefore be the optical component or element of an optical system which is located closest to the scene being photographed.

In one alternative embodiment an objective lens assembly may be arranged to reproduce the same scope of the field of view normally presented by the camera. In such embodiments the lens system may preferably be employed to redirect the direction of view of the camera, with the objective lens being used to ensure that the same field of view is presented to the camera.

However in a variety of alternative embodiments an objective lens may be employed to modify the default or normal field of view of a camera. For example in range of embodiments an objective lens assembly may provide, implement or assist in the implementation of a wide angle lens, fisheye lens, zoom lens or macro lens which can modify the default field of view experienced by camera.

Reference in general throughout this specification will also be made to various embodiments of the invention employing an objective lens to implement a lens system which modifies the default or normal field of view of the camera. Those skilled in the art will appreciate that an objective lens assembly may in isolation provide a modification to cameras field of view, or alternatively may modify the field of view in combination with a further optical elements or components integrated into the lens system which do not form part of the objective lens assembly. References to various forms of field modification lenses being implemented by an objective lens assembly should therefore be interpreted to also encompass the possible use of optical elements in addition to an objective lens assembly to provide the field modification effect required.

In a preferred embodiment the optical system of a lens system may also include a convergent lens assembly. A convergent lens assembly is arranged or characterised by its ability to focus more tightly the spread of light passing through the lens assembly. A convergent lens assembly provided by the invention can be employed to initially restrict the cameras field of view as light travels through the optical system, thereby reducing the size of any reflective optical element. This in turn allows for the size of the housing be minimized, providing a compact and convenient lens system in accordance with the invention.

Those skilled in the art will appreciate that the convergent lens assembly may be implemented in a number of different arrangements in various embodiments. For example in one possible embodiment a convergent lens assembly may be sandwiched or positioned between a reflective element and an objective lens assembly, or in another embodiment may be provided as or by the objective lens assembly. However, in a further preferred embodiment a convergent lens assembly may be located by the housing directly next to the camera, so that a reflective element is sandwiched and positioned between the objective lens assembly and convergent lens assembly.

In one embodiment, the optical system may be based on a Galilean telescope with the reflective element inserted between the two lens groups. In these cases the convergent lens group is positioned nearest the camera so the lens system behaves as a wide angle lens. This system may utilize a portion of the camera's image sensor, thus allowing for a reduction in the size of the optical system, while still capturing a normal angle of view.

In another embodiment, the optical system may be modeled on a Keplerian telescope with a magnification close to or equal to one. This arrangement is similar to a relay lens system. The reflective element may be inserted between two lens groups or immediately after the camera window.

More complex optical systems may also be implemented to reduce optical aberrations or correct for image inversion and mirroring.

The housing may be designed to allow for a rotation of the optical axis in one or more directions in a similar way to snorkel lenses. In such embodiments the housing can for example include a snorkel lenses assembly adapted to allow rotation of the optical system.

In some embodiments any lens or lenses provided in the optical system may have a rectangular rather than a round form. In such embodiments the depth of the housing can be reduced. For example, in one particular embodiment when the camera image sensor is rectangular and a 90 degree change in direction is provided by the lens system, the tighter angle of view is aligned in such a way that the lens system could be made thinner.

The width of the objective lens group (lenses closest to the scene) constrains the minimal depth of the housing. By minimizing the width of this lens group the depth of the housing can be reduced, thus reducing the profile of the housing when attached to a camera, which makes it less visible. If the camera's image sensor is rectangular then the lens group width can be reduced relative to the lens group height, without impacting the image captured by the sensor, thus reducing the depth of the housing.

As indicated above a further aspect of the invention provides executable instructions arranged to provide a software application adapted to manipulate and/or improve an image captured by the camera.

Those skilled in the art will appreciate that references throughout this specification to software applications encompass the provision of computer executable instructions stored on computer readable mediums, methods enabled by such instructions in addition to portable programmable devices programmed with these instructions. A software application provided by the invention also allows for the provision of portable programmable device being programmed with executable instructions, in addition to an image capture and modification system which includes a portable programmable device with this software installed and a removable lens system as provided by any other aspect of the invention.

Reference in general throughout this specification will also be made to the invention providing a software application used in combination with a lens system which changes the direction of a cameras field of view. However, those skilled in the art will also appreciate that other forms of lens system which do not necessarily change the direction the field of view of the camera may also employ the software provided in accordance with the invention.

The software application may be able to be downloaded to the camera or portable programmable device, for example from a website or cloud computing site.

Preferably, the software application may be adapted or able to reduce the impact of optical aberrations and/or improve the perceived image quality. Preferably the software application may use or provide a correction function, or potentially combination of a number of correction functions which are arranged to correct for the effects of optical deficiencies of the lens system. Those skilled in the art will appreciate that a wide variety of known correction functions may be utilized to implement the aims of the present invention.

In a preferred embodiment a correction function may receive as an input parameter an identifier related to the camera or the portable programmable device which integrates this camera. This camera identifier can be used to determine the form or construction of optical elements present within the camera and in turn can be used to optimize or tailor the process completed by a correction function.

In yet other embodiments the software employed may receive a camera identifier which is in turn used to select a particular correction function optimized for the optical components of the camera involved.

A camera identifier may be provided to the software by—for example—a user interface system, allowing a user of the invention to enter the make, model and/or year of manufacture of their programmable device. In other embodiments an installation process employed to load the instructions of the software to a user's programmable device may interrogate the device to receive the required camera identifier.

In these aspects of the invention the software application provided is arranged to output at least one corrected image. The corrected image may be provided as output, for example, presenting the image on a display screen, saving the corrected image to a digital file system, and/or supplying the corrected image as an input parameter to a further process executed by the programmable device.

Optical aberrations cause information to be lost when the image is captured by the camera. It is impossible to get that information back but it is possible, by virtue of the use of the software, to reduce the visibility of the associated distortions.

In one embodiment, the software application may be adapted to manipulate, and/or improve the quality of, the image captured by the camera by applying digital signal processing algorithms to the image.

For example geometrical distortions such as barrel distortion can be corrected, aberrations resulting in lens softness can be reduced using local contrast enhancement, color fringing can be reduced, and/or vignetting can be reduced.

The scene orientation may also be modified by the optical system, for example by introducing inversion or mirroring, and these effects can be removed by a correction function performed by the software.

According to a further aspect of the invention there is provided a method of image capture and modification which includes the additional of

i. receiving at least one input orientation indication from one or more orientation sensors associated with the programmable device,

ii. applying at least one translation function to an input image

iii. outputting at least one corrected image

wherein an input parameter of said translation function is the orientation indication received from an orientation indication sensor

According to another aspect of the invention there is provided a method of image capture and modification which includes the additional of

i. receiving at least one input orientation indication from one or more orientation sensors associated with the programmable device,

ii. applying at least one translation function to an input image

iii. generating a cropped image by selecting a sub-region of a translated image

iv. outputting said cropped image

wherein an input parameter of said translation function is the orientation indication received from an orientation indication sensor.

Preferably an orientation indication can identify the degree of any vertical or horizontal tilting of the camera. This information can then be used as an input to a translation function to correct for this tilting and provide an output image with a standard orientation to a user.

In a preferred embodiment a translation function includes an image rotation function. Image rotation functions allow an image to be modified to present an expected orientation to a user—irrespective of whether the camera is tilted at an angle for ease of viewing by the user.

In such embodiments the software application may allow for improved usability when the mobile device is held in a natural position for consulting information on the mobile device.

For example, when using a mobile device for photography the device is typically held so the camera is aligned vertically. However when using a mobile device for other activities such as consulting information or playing games the device is typically held at a slight inclination to offer a comfortable viewing position. When the direction of the field of view is modified by the housing to be at right angles to the camera's normal orientation, holding the mobile device at an inclination will cause the scene to appear on the screen as if it is rotated. If the software application on the mobile device is capable of detecting the inclination of the device, which is typically provided by accelerometers integrated into the mobile device, then the software application can automatically rotate the image displayed on the screen so as to present the scene without any rotation induced by holding the mobile device in an inclined position. This allows the photographer to use the screen comfortably for viewing the scene while holding the device at an inclination that does not indicate the use of the mobile device's camera function.

The software application can also provide an automated zoom or crop function used in combination with such translation functions. A crop function may be adapted to generate a cropped image by selecting a sub-region of a translated image. This cropped image may then be provided as an output of the software provided.

This is useful when the image is being translated and in particular, rotated so that the scene fills the image and screen rather than having corners where no image data is available. This can also be useful if only part of the image sensor is used when the housing is in place, in this way the scene fills the image and mobile device's screen. In such embodiments a cropped image will be provided showing a selected sub region of the original image, preferably with squared off straight corners and potentially cropping out regions of the image which may be distorted.

As indicated above a further aspect of the invention provides a light pipe which may be used in combination with elements of the invention provided in accordance with other aspects.

In a further aspect of the invention there is provided a light pipe which includes a body, inlet and at least one outlet substantially as described above. In a number of further aspects of the invention a lens system may include one or more light pipes.

Preferably the angled orientation of the light pipes inlet and an outlet redirects light received by the body by the angle made between the inlet and the outlet.

Preferably the angled orientation of the inlet and an outlet redirects and emits light received by the body towards the direction faced by the optical system of the lens system. Preferably, the optical system is arranged to re-direct by a desired angle the direction of view of the camera system of a portable programmable device which the lens system is attached to, and the light pipe is arranged to redirect light emitted by the light source of the portable programmable device by the same desired angle. In a further preferred embodiment the light pipe redirects light by a substantially 90 degree angle.

Preferably the inlet is arranged to receive light into the body which is transmitted by a light source provided by a portable programmable device.

A light pipe provided in accordance with the invention includes a body which defines or provides an optical waveguide. This waveguide body can preferably be formed by an element which channels light from an inlet to one or more outlets without substantial attenuation or loss. This waveguide body made have a rigid form in some embodiments with one or more curves or bends being formed in the body to implement the light direction facility to be provided. In other embodiments the waveguide body may have a substantially flexible nature allowing it to be conformed or shaped to any particular angling of the inlet to an outlet.

In some embodiments a light pipe, similar to light pipes used in consumer electronics for LED illumination, can be used to redirect the flash from the mobile device in the direction of the housing's field of view. Those skilled in the art will appreciate that in some embodiments a waveguide body may be provided by, for example, a fiber optic element or alternatively in other cases by a hollow tubular material with a reflective interior surface.

In some embodiments a light pipe may also be provided with two or more outlets.

In some embodiments the invention may provide a light pipe with two outlets, each of said outlets being arranged to emit light at a substantially 90 degree angle to each other.

In other embodiments a lens system may include two light pipes, an outlet of each of said two light pipes being arranged to emit light at a substantially 90 degree angle to the light emitted by the remaining light pipe.

In some embodiments the lens system housing may include at least one channel arranged to at least partially enclose and locate the body of a light pipe.

In other embodiments the lens system housing may include at least one cavity arranged to fully enclose and locate the body of a light pipe.

In yet other embodiments the lens system housing an exterior surface of a lens system housing may be connected to the body of a light pipe.

Preferably a light pipe inlet is formed by flat terminal end of the waveguide body and a perimeter locating system. For example in such embodiments an inlet may simply be formed by squaring off or flattening the end of the waveguide body and surrounding the perimeter of the end of the body with a locating collar. This locating collar may provide a perimeter locating system and may include—for example—a magnetic element or alternatively a self-adhesive material used to align and locate the inlet with a light source.

Preferably a light pipe outlet may be formed by flat terminal end of a waveguide body. Again in such embodiments an end of the waveguide body distal from the inlet may be squared off or flattened to form at least a part of a light pipe outlet.

In some embodiments a light pipe outlet may include a diffusion lens mounted to the flat terminal end of a waveguide body. A diffusion lens can spread the beam of a point or focused light source over a greater area of the field of view to be recorded by the camera.

### BRIEF DESCRIPTION OF THE DRAWINGS

The descriptions preferred forms of the invention to be provided herein, and with reference to the accompanying drawings, are given purely by way of example, and are not to be taken in any way as limiting the scope or extent of the invention:

FIG. 1: is a view of one possible embodiment of a housing attached to a mobile phone,

FIG. 2: is a view of the front of the housing of FIG. 1,

FIG. 3: is a view of the side of the housing of FIG. 1 showing the lens which is closest to the scene being photographed,

FIG. 4: is a view of the housing of FIG. 1 showing the slot where the mobile phone is inserted into the housing,

FIG. 5: is a view of the housing of FIG. 1 showing the side with the lens closest to the scene, the back and the top,

FIG. 6: is a view of a cross section of the housing of FIG. 1 showing the layout of the two lens assemblies and front side mirror,

FIG. 7: is a view of the housing of FIG. 1 in the closed position,

FIG. 8: is a view of a light pipe used in the embodiment illustrated with respect to of FIG. 1,

FIG. 9: is a view of the image processing process used in the embodiment illustrated with respect to of FIG. 1,

FIG. 10: is a further view of the optical system used in the embodiment illustrated with respect to of FIG. 1,

FIG. 11a shows a side perspective view of a lens system provided in accordance with a further embodiment which is removably attached to a smart phone,

FIG. 11b shows a side view of the lens system and smart phone illustrated in FIG. 11a,

FIG. 12 shows a view of the lens system of FIG. 11a, 11b when removed from the smart phone,

FIG. 13 shows a rear perspective view of the optical system of the lens system of FIG. 11a, 11b,

FIG. 14 shows an end cross-section perspective view of a lens system provided in accordance with yet another embodiment when removably attached to a smart phone,

FIG. 15 shows a cutaway view of the lens system of FIG. 14 illustrating the orientation of a pair of light pipes provided in the interior of the housing of the lens system,

FIGS. 16a, 16b and 16c show a number side and rear perspective views of a lens system provided in accordance with yet another embodiment where the housing of the lens system also forms a case for a smart phone,

FIGS. 17a, b and c shows a perspective and a pair of cross-section views of elements of a lens system housing provided in accordance with a further embodiment of the invention,

### BEST MODES FOR CARRYING OUT THE INVENTION

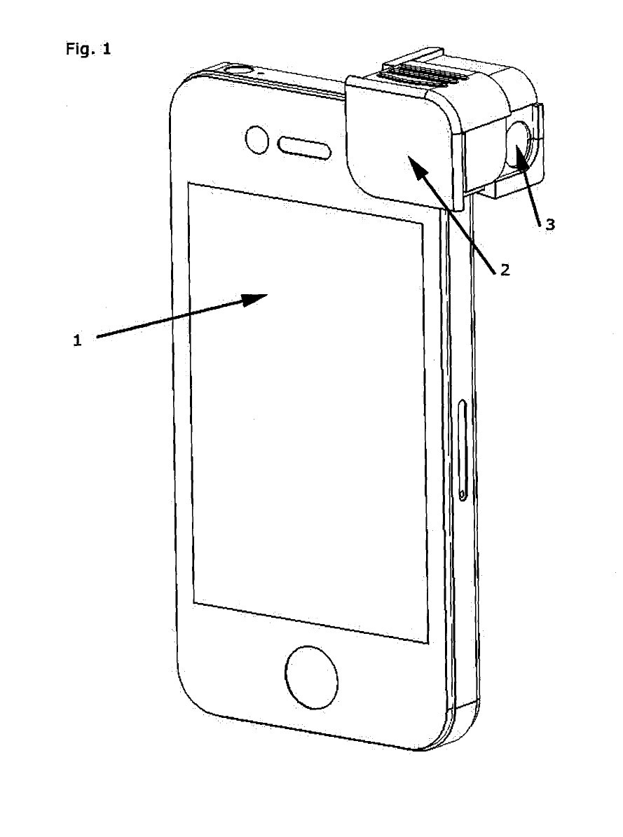

FIGS. 1-10 show the implementation of one embodiment of the invention when arranged to operate in conjunction with the camera of a mobile phone.

Having regard to FIG. 1, there is shown a lens system for a camera.

The lens system includes a housing 2 which is attachable to a camera incorporated within a mobile phone 1.

The housing 2 includes an optical system which is adapted to change the direction of the field of view of the camera associated with the mobile phone 1. The optical system 3 includes a lens which is oriented at a 90 degree angle relative to the optical axis of the mobile phone camera.

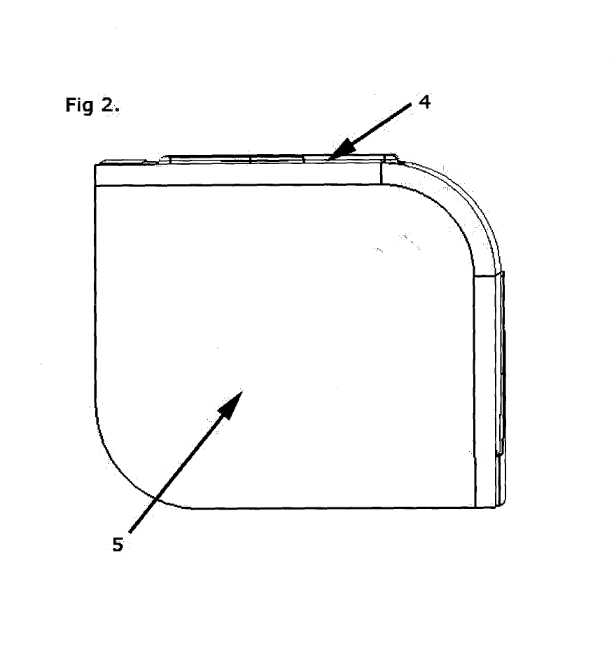

Having regard to FIG. 2, there is shown a front view of the housing 2. This serves to hold the housing 2 in place on the mobile phone. The front of the housing 5 and top 4 are visible.

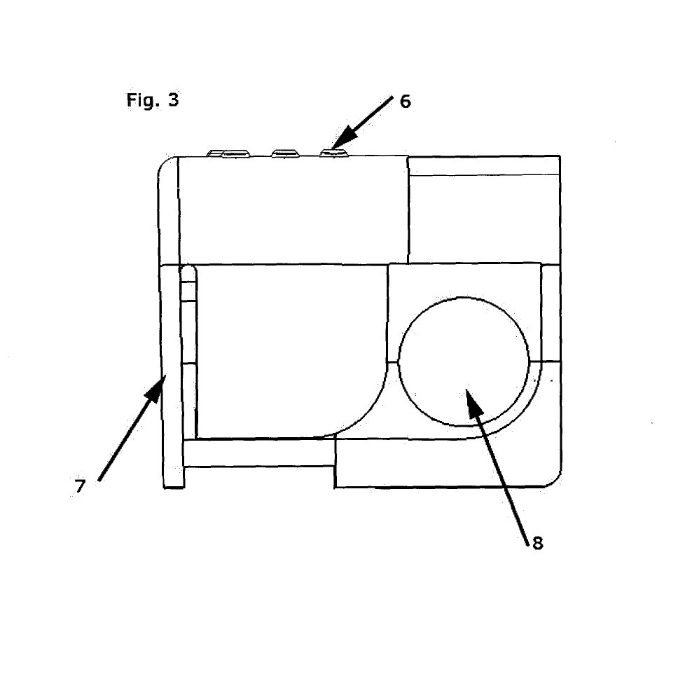

Having regard to FIG. 3, there is shown a side view of the housing 2. The front of the housing 7 and top 6 are visible, as is an objective lens 8 which is aligned with the scene to be photographed or filmed.

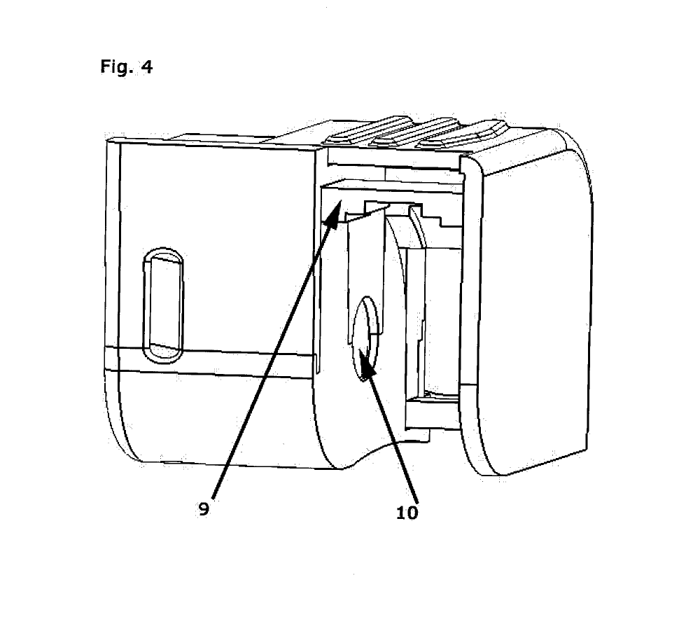

Having regard to FIG. 4, there is shown a side view of the housing 2 with a sliding bar 9 visible. FIG. 4 also shows an additional element of the optical system 4, being a convergent lens 10 which is centered on the camera window of the mobile phone.

Having regard to FIG. 5, there is shown a view of the housing 2 which illustrates the back 12, top 11 and side with the objective lens 8.

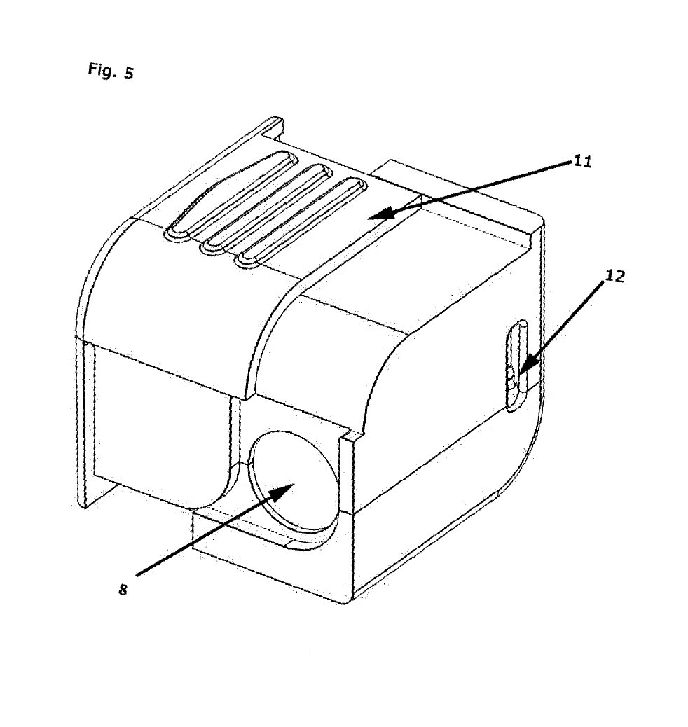

Having regard to FIG. 6, there is shown a cross section of the housing 2. The lens groups 8 and 10 form an inverted Galilean telescope. The mirror 15 redirects the optical axis of the mobile phone camera 90 degrees, to the side of the mobile phone. The front of the housing 17 is also shown.

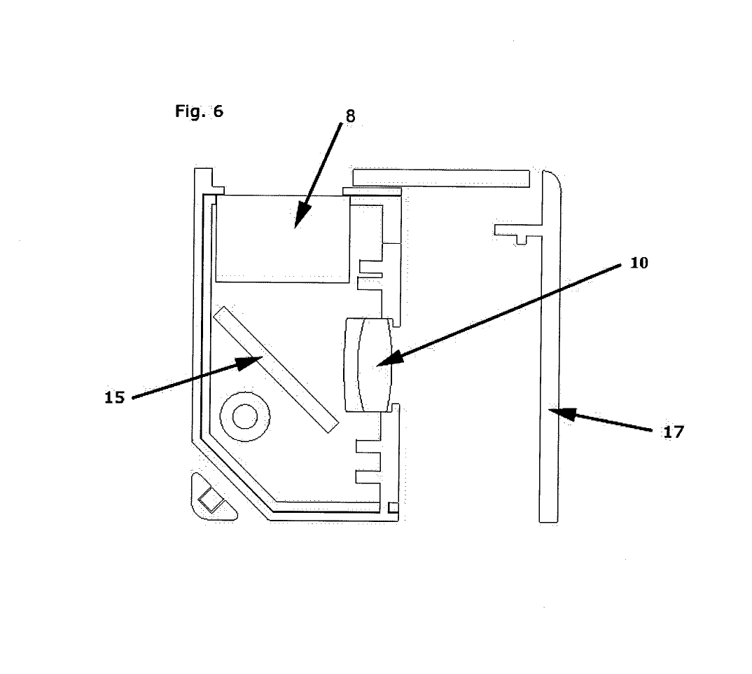

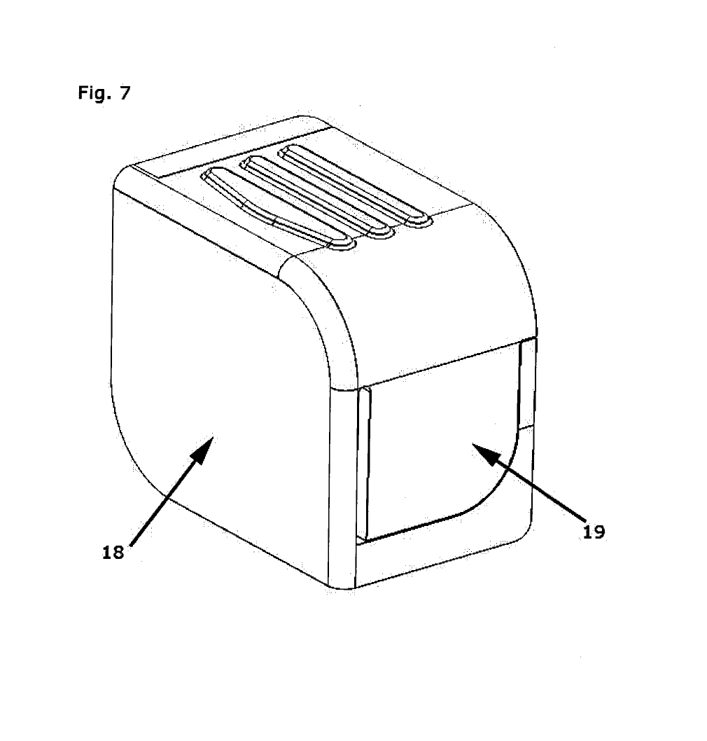

Having regard to FIG. 7, there is shown the housing 2 in the closed position. The front 18 is pushed toward the back of the housing 2. Part of the side of the housing 19 covers and protects the lens.

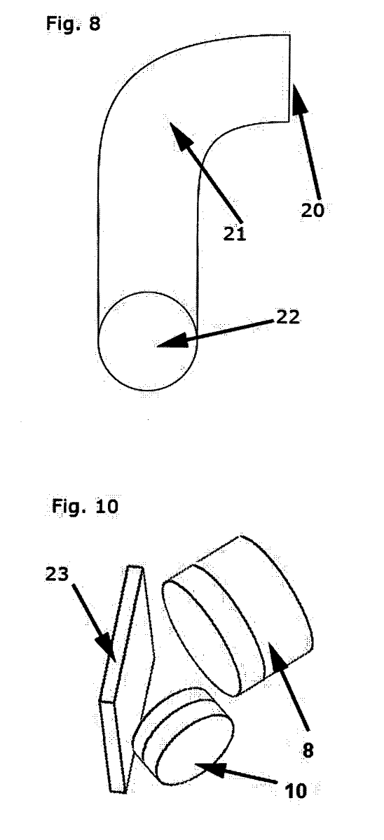

Having regard to FIG. 8, there is shown a light pipe. Light enters one end 20, the tube is bent at an angle 21 and the light is emitted from the other end of the light pipe 22 which is facing a different direction from the entry 20.

Having regard to FIG. 9, there is shown a flowchart describing an example of the processes performed by the software application installed on the mobile phone.

Having regard to FIG. 10, there is shown the optical system with the objective lens group 8 which is closest to the scene, convergent lens group 10 and mirror 23. Light rays enter the objective lens group 8 are reflected 90 degrees by the mirror 23 and pass through the convergent lens group 10 toward the mobile phone's camera lens.

The dimensions of the mirror 23 in the embodiment shown are a square of 11mm (although it could be a larger or smaller).

The housing 2 is held in place on the mobile phone by a case that fits tightly to a corner of the mobile phone. The mobile phone depicted is the iPhone 4 sold by Apple Inc.

Each lens group 8, 10 (FIG. 6) is comprised of an achromatic doublet. Lens 8 is divergent with diameter of 9 mm and focal length of −12 mm and 10 is convergent with diameter of 6 mm and focal length of 6 mm. The lenses are configured as a Galilean telescope with a magnification of 0.5. Only a reduced area, approximately 40%, of the camera's sensor is used for capturing the scene. Because of the 0.5 magnification a field of view similar to the camera's standard field of view is obtained in the fraction of the sensor that is used. This allows the size of the mirror and lenses to be reduced while preserving the field of view.

A mirror 15 (FIG. 6) is placed at a 45 degree angle to the camera lens window. This changes the direction of the field of view by 90 degrees. With the mobile phone held vertically, the direction of the field of view is towards the right of the mobile phone instead of directly in front of the mobile phone. Lens group 10 is convergent which allows the size of the mirror to be reduced while still occupying a large portion of the field of view.

A software application is installed on the mobile phone. This embedded application implements the process depicted in FIG. 9. The user positions the housing on the mobile phone then starts the embedded application 100. Upon tapping a button on the screen the application reads the image data from the camera sensor 110. Concurrent with action the process shown also records the orientation of the camera by interrogating at 130 a number of camera orientation sensors. This is done by interrogating the phone's embedded accelerometer.

At this stage the process also detects the identity or model of the camera 115 to provide a match with stored calibration data. A correction function is implemented by an image processing algorithm 120 which corrects for geometrical lens distortion. This algorithm uses the camera identity information obtained at step 115 as an input parameter to retrieve appropriate camera calibration data. The software library OpenCV 2.2 is used to facilitate the image processing. The geometrical distortion is calibrated by following the OpenCV guidelines, this involves taking a series of photos of a checkerboard and processing these images with a calibration application. The cvInitUndistortMap function in the OpenCV library initializes the constants required to correct the geometrical distortion in the image, the correction is applied with the cvRemap function. The principal geometrical distortion present is barrel distortion.

The correction of lens distortion for cameras using software is well known, many desktop computing applications provide this functionality. Programmers familiar with image processing for computer vision systems may calibrate camera systems in a similar way. The major steps for calibrating a camera are:

1) Using a physical reference image, such as a printed checkerboard, take photos from a wide variety of orientations and distances. It is important that most of the camera's field of view is covered by the reference object in one or more of the images.

2) These images are used to calculate the distortion matrix and camera matrix. Detailed explanations and source code are available from the open source OpenCV software library.

3) The calibration data is hard coded into the mobile device application. A single application can support multiple devices by interrogating the device identity information and selecting the appropriate calibration data.

4) The mobile device runs the “undistort” function from the OpenCV library. The OpenCV library has been ported to popular mobile devices such as iPhone. The OpenCV documentation provides detailed explanations of how to implement the undistort process.

Because there is a single reflective element in the optical sub-system the scene is mirrored, to correct for this the image is flipped using the OpenCV flip function. Flipping the image in software saves adding additional elements to the optical sub-system to correct for the mirror effect.

After correcting for geometrical distortion and mirroring the embedded application assesses at stage 140 the orientation of the mobile phone. The inclination of the mobile phone relative to the vertical position is used to calculate the rotation of the image. The inclination results in a rotation because of the 90 degree change in the direction of the camera's field of view. If the phone is inclined, an image processing algorithm (an affine transform) is then applied at step 150 to correct the rotation of the image so the image will appear as if the mobile phone had been held vertically. This allows the photographer to hold the phone in a position that is natural for consulting information such as email on the mobile phone. The photographer does not need to manually correct the rotation of the image caused by the inclination of the mobile phone. This is particularly useful when previewing the scene to be photographed because the photographer is not tempted to rotate their head to align with the image on the screen. Rotating the head in this way would draw attention to the photographer because it is not a typical behavior when consulting a mobile phone.

Because the entire sensor of the mobile phone camera is not used the edges of the image would appear to be black. Therefore the image is cropped 160 by the embedded application, this ensures the scene fills the image and the photograph appears similar to photographs taken with the camera when no housing is used. If the phone was inclined this cropping function also selects a sub-region of the rotated image to provide an output cropped image with a normal square or rectangular form. The cropping operation can also be considered as a digital zoom. The camera's image sensor is rectangular with a 4:3 aspect ratio. The cropping is symmetrical and related to the degree of rotation. If the image is rotated 45 degrees then the crop is maximized to ensure that the final rectangular image is filled with the scene.

After making the modifications to the image it is saved to the user's photo library on the mobile phone 170 and presented to the user for viewing 180.

To facilitate photography in low light conditions a flash is provided on the mobile phone. However in this embodiment the invention is employed to change the direction of the field of view so the flash of the mobile phone is not oriented in the new direction. To re-orient the direction of the flash a light pipe (FIG. 8) can be integrated into the housing.

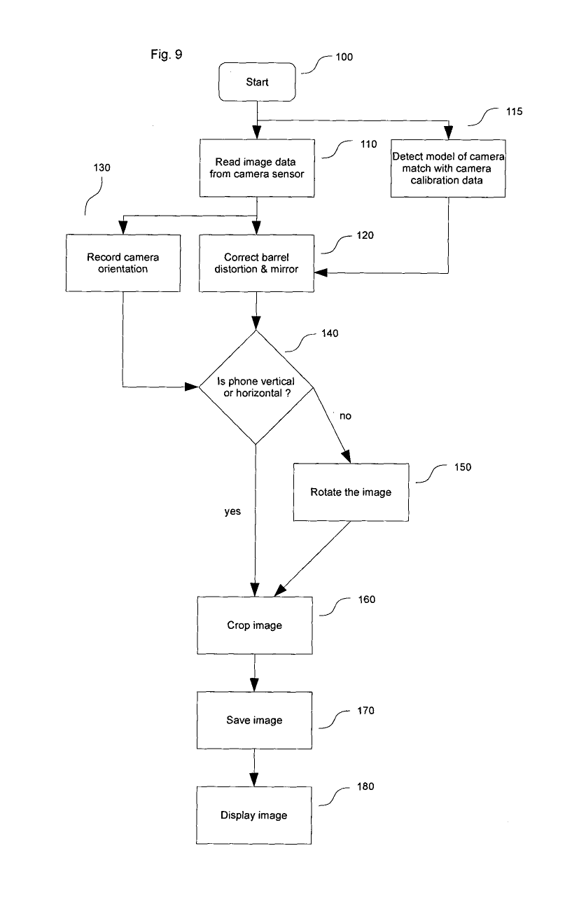

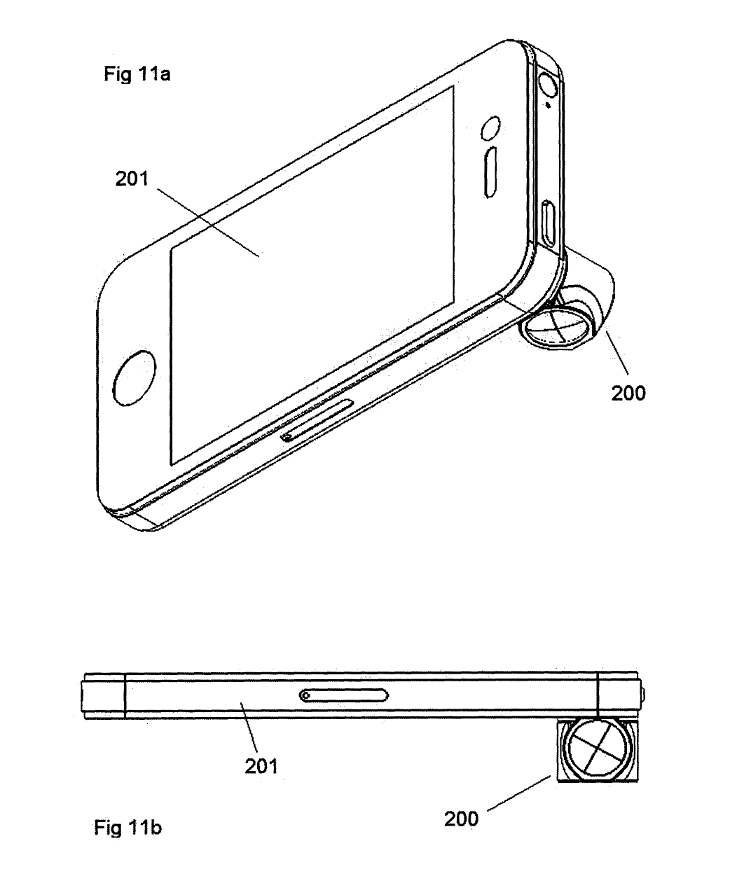

FIG. 11a shows a side perspective view of a lens system 200 provided in accordance with a further embodiment which is removably attached to a smart phone 201. FIG. 11b shows a side view of the lens system 200 and smart phone 201 illustrated in FIG. 11a.

In the embodiment shown in these figures the lens system is removably attached to the rear face of the smart phone 201 in alignment with the smart phone's camera (not shown). As can be seen from FIGS. 11a, 11b in this embodiment the lens system is used to redirect the direction of view of the smart phone's camera by 90° for low angle image shots. In this embodiment a user simply needs to hold the smart phone naturally and direct the lens system 200 towards the scene to be recorded. Software provided in accordance with a further aspect of the invention can also be used to adjust for any tilting of the smart phone as a user holds it in a comfortable orientation.

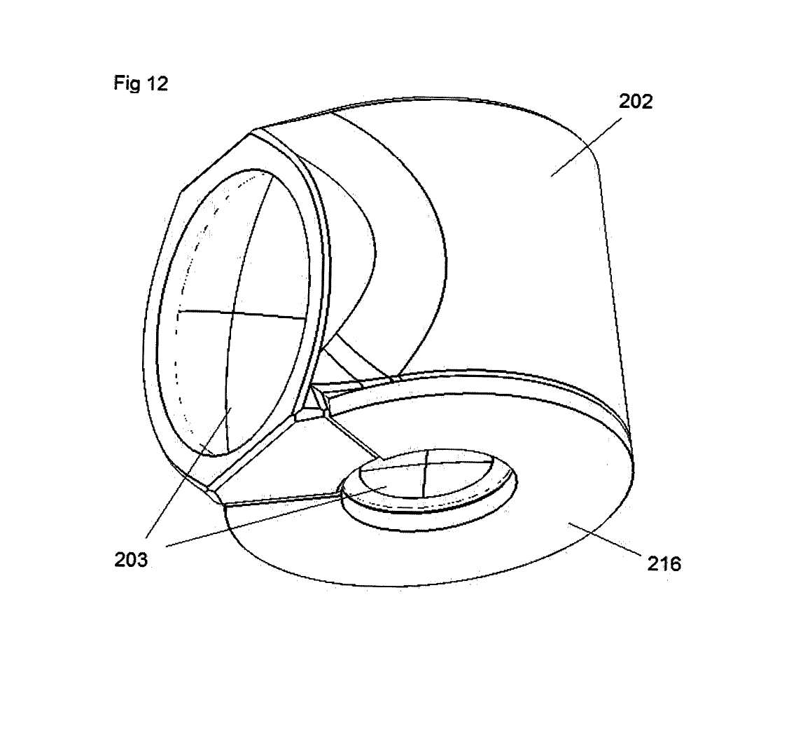

FIG. 12 shows a view of the lens system 200 of FIG. 11a, 11b when removed from the smart phone 201. This figure illustrates how a housing 202 of the lens system 200 is used to locate a number of components of an optical system 203 integrated into the lens system. FIG. 12 also shows the provision of an attachment system used to removably attach the underside of the lens system to the rear face of the smart phone 201 in alignment with the smart phone's camera. This attachment system is implemented by a self-adhesive backing material applied to an exterior surface of the housing. In the embodiment shown this self-adhesive backed material is provided by a polyurethane gel sheet backing 216 applied to the rear exterior surface of the housing 202. This self-adhesive backing 216 secures the housing 202 on the smart phone 201 in the orientation which a user places the housing 202 on top of the smart phone's camera. The housing 202 can be removed from the smart phone at will by a user simply by applying a degree of force to pull the housing from the smart phone 202.

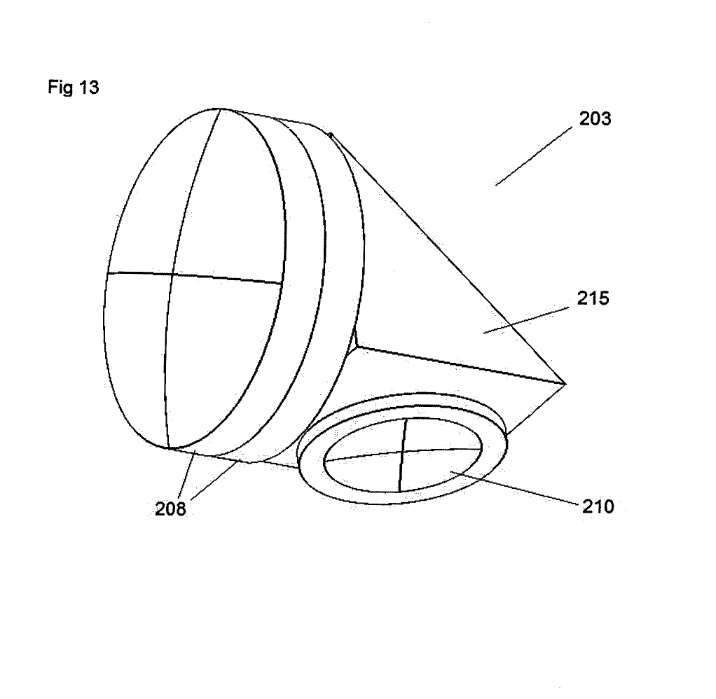

FIG. 13 shows a rear perspective view of the optical system 203 of the lens system 200 of FIG. 11a, 11b. In the embodiment shown the optical system 203 is made up of an objective lens assembly 208, a reflective element formed by a prism 215, and a convergent lens 210.

The convergent lens 210 is combined with the prism 215 to minimise the overall size of the resulting lens system 200. The convergent lens 210 gathers all the light received via the prism 215 and converges it on to the camera (not shown) of the smart phone 201. The prism 215 forms a compact reflective element which is capable of redirecting light received from the objective lens assembly 208 by a 90° angle.

In the embodiment shown the optical system 203 is arranged to both redirect the direction of view of a smart phones camera in addition to modifying the field of view of the camera through use of the objective lens assembly 208. In the embodiment shown the objective lens assembly provides a wide angle lens which increases the width of the default field of view of the smart phones camera. In other embodiments the objective lens assembly may modify the cameras default field of view in other ways through, for example the use of a macro lens, fisheye lens zoom lens or any other suitable desired lens system as the objective lens assembly.

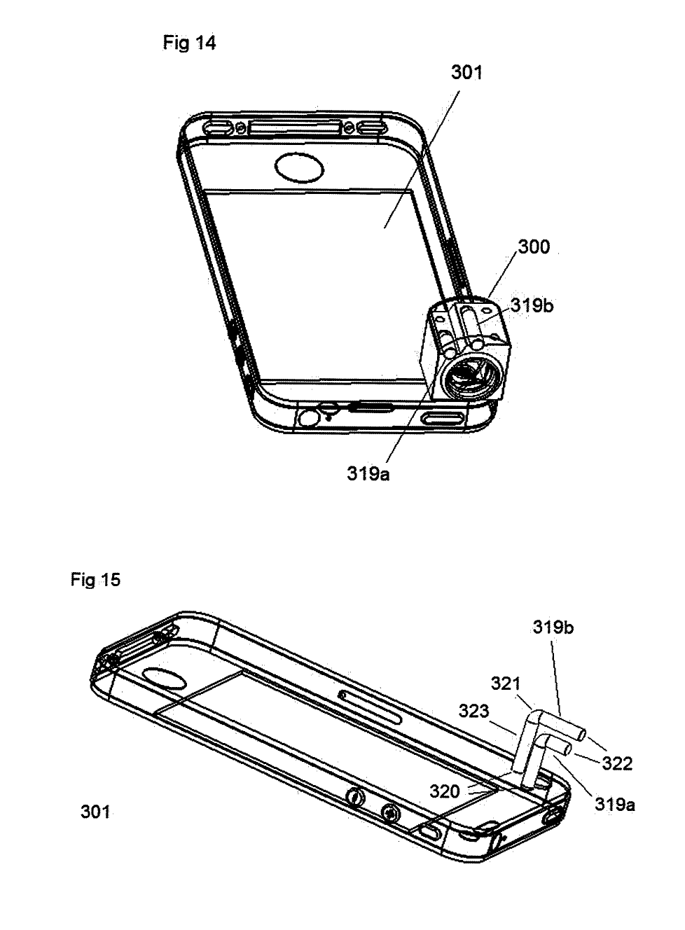

FIG. 14 shows an end cross-section perspective view of a lens system 300 provided in accordance with yet another embodiment when removably attached to a smart phone 301.

The embodiment shown with respect to FIG. 14 includes a number of equivalent features the embodiment discussed with respect to FIGS. 11a, b, 12 and 13. In the embodiment shown the lens system 300 is used to re-orientate the direction of view of the smart phones camera by 90°.

However in this embodiment the lens system 300 incorporates a housing 302 which integrates, locates and orientates a pair of light pipes 319a, 319b. These light pipes are used to redirect light emitted from the flash light source of the smart phone towards the direction which the lens system 300 redirects the smart phones camera.

FIG. 15 shows more clearly the orientation this pair of light pipes 319a, 319b provided in the interior of the housing 302 of the lens system 300 shown with respect to FIG. 14.

Each light pipe 319 includes a single inlet 320 and a single outlet 322 formed by a waveguide body 323. In the embodiment shown the waveguide body 323 is provided by flexible length of fiber optic cable which is bent at the angled section 321 shown to redirect light received by the inlet 320 towards the direction faced by the outlet 322. As can be seen from FIG. 15 the inlet 320 is angled with respect to the outlet 322, meaning that light entering the inlet is redirected by the angle made between the inlet and the outlet.

Two different arrangements of light pipes 319 are provided to allow the camera flash to be re-directed when the lens system 300 is attached to the smart phone 301 with two different orientations. FIGS. 14 and 15 show the orientation of the lens system 300 attached to the smart phone 301 when used to capture high angle images. With this arrangement the smaller of the two light pipes 319a is aligned with the smart phones flash light source (not shown). Conversely, for low angle images the lens system 300 is rotated anticlockwise by 90° and then secured again to the smart phone 301. In this configuration the second light pipe 319b is aligned with the smart phones flash light source (not shown).

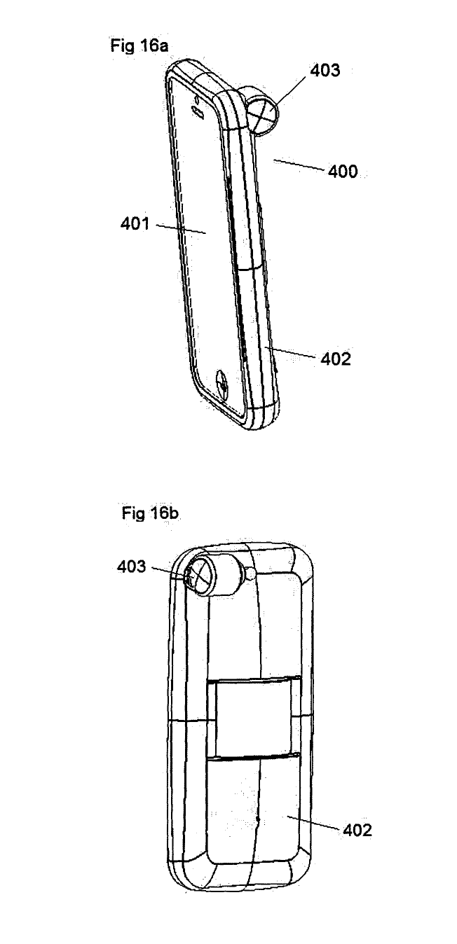

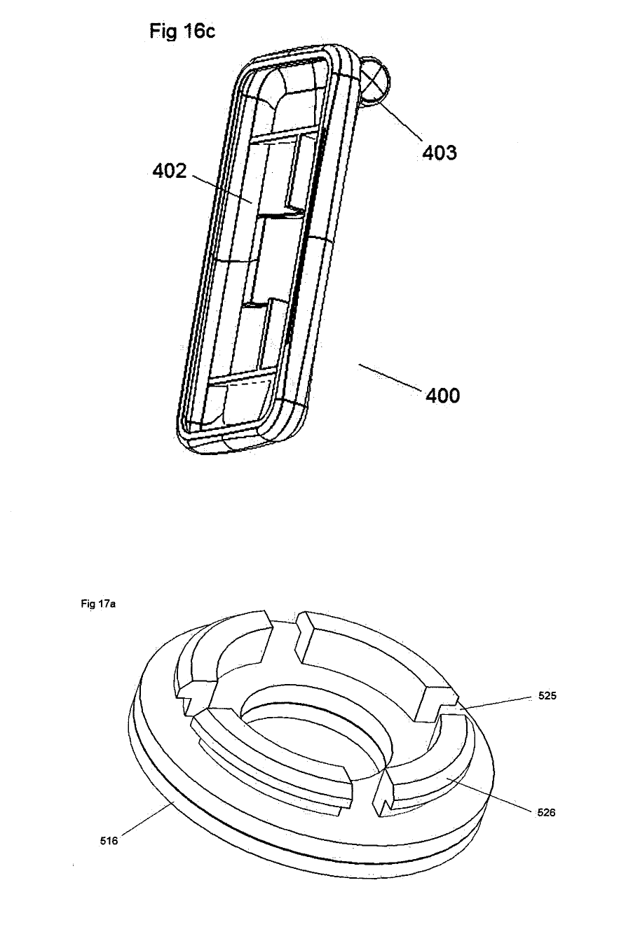

FIGS. 16a, 16b and 16c shows side and rear perspective views of a lens system 400 provided in accordance with yet another embodiment where the housing of the lens system also forms a case for a smart phone 401.

In the embodiment illustrated in these figures the lens system dispenses with the stand alone housings discussed with respect to the alternative embodiments referenced above. In this embodiment the housing also forms a case 402 which encloses the sides and rear face of the smart phone 401.

The front perspective view provided as FIG. 16a shows how this case 402 locates the optical system 403 of the lens system 400, and orients this optical system 403 to redirect the normal direction of the field of view of the smart phone's camera by 90°.

The rear perspective view provided as FIG. 16b shows the orientation of the optical system 403 and how it projects from the rear of the smart phone 401 located inside the case 402.

FIG. 16c shows the lens system 400 with the smart phone 401 removed, illustrating the volume normally occupied by the smart phone 401 and how the side walls of the case 402 grip the sides of the smart phone and extend over on to the edge of the smart phones front face.

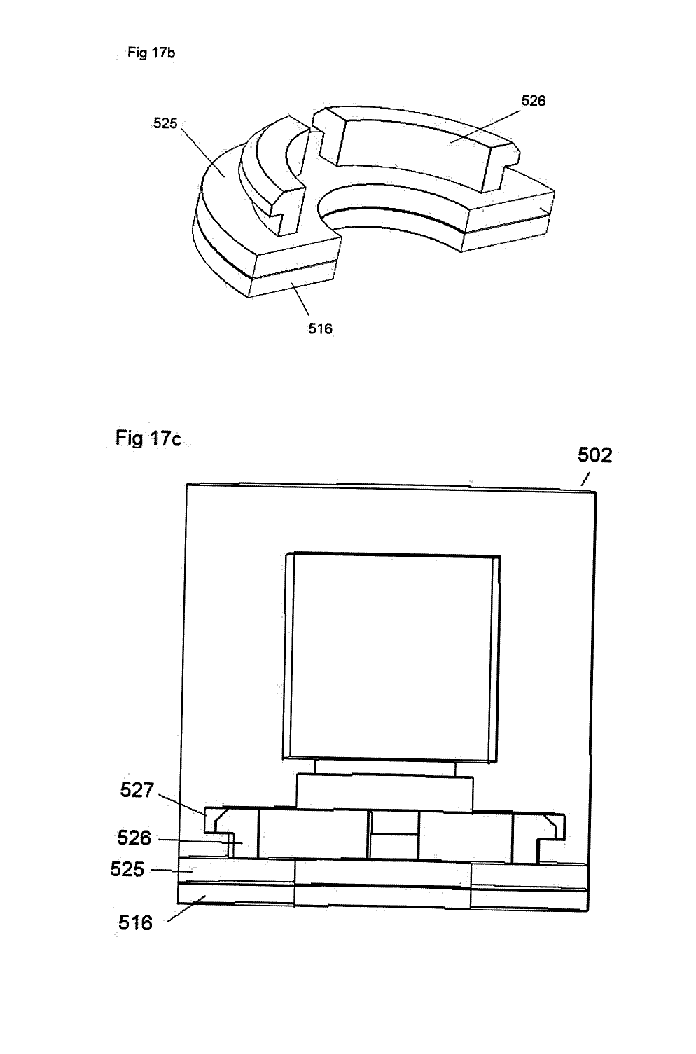

FIGS. 17a, b and c shows a perspective and a pair of cross-section views of elements of a lens system housing provided in accordance with a further embodiment of the invention.

FIG. 17a shows the provision of a turntable base 525 provided as part of a lens system housing 502 in a further embodiment. The embodiment illustrated includes a turntable base 525 connected to a self-adhesive backing 516 provided for the housing. The turntable base includes a number of locking projections 526 which have a complimentary form to a rebated shelf 527 formed in the upper section of the housing 502—as shown with respect to FIG. 17c. These locking projections 526 sit inside the rebated shelf 527, while allowing the upper section of the housing to rotate relative to the turntable base 525 which is held on in a stationery orientation on a smart phone (not shown) by the self-adhesive backing 516.

Some advantages associated with the invention in a variety of embodiments include (but are not limited to) the following:
1. The invention allows for a change in direction of the field of view of a mobile phone generally.
2. The invention allows the photographer to hold the mobile device in a natural position for consulting information on the mobile device while the screen displays the scene to be photographed which is in a different direction from the normal optical axis of the mobile device's camera.
3. Use of the invention enables a photographer to line up and/or take a photograph whilst appearing not to be doing so, and hence people in a scene to be photographed will not be tempted to pose for, and/or hide from, the camera.
4. Use of the invention means that people in a scene to be photographed are less likely to be distracted from the activity they are engaged in.
5. The invention is small and unobtrusive and does not draw attention to the modified nature of the mobile device's camera.
6. The invention may be portable and/or reusable across a range of mobile electronic devices.
7. The invention is relatively simple to operate and is relatively small and inexpensive.
8. The invention does away with the use of tilt and swivel screens which can be large, obtrusive, unwieldy, expensive and complex.
9. The invention includes a software application which is adapted to manipulate and/or improve the image captured by the camera.
10. The invention can help look over the top of crowds by holding the camera, such as an iPhone, with the screen directly above ones head. The camera is oriented toward the horizon which makes it easy to align photos while looking “over” obstacles.
11. Another advantage or use is for taking “street level” shots where the camera is very low to ground level. In this situation the user can look comfortably down on the screen while the camera is oriented along the street.

### VARIATIONS

Embodiments of the present invention comprise a software product, or carrier medium carrying instructions to perform any of the methods described herein or perform any of the processes performed herein, or to perform processes which configure hardware to perform processes or provide the apparatus described herein. For example, the instructions may be source or object code, or compiled firmware, or instructions in Varilog or VHDL.

Further, it is to be understood that the present invention is not limited to the embodiments described herein and further and additional embodiments within the spirit and scope of the invention will be apparent to the skilled reader from the examples illustrated with reference to the drawings. In particular, the invention may reside in any combination of features described herein, or may reside in alternative embodiments or combinations of these features with known equivalents to given features. Modifications and variations of the example embodiments of the invention discussed above will be apparent to those skilled in the art and may be made without departure of the scope of the invention as defined in the appended claims.

1-56. (canceled)

57. A lens system adapted for removable connection to a portable programmable device which includes a camera, the lens system including
an optical system arranged to re-direct by a desired angle the direction of view of the camera of a portable programmable device to which the lens system is attached, the optical system including
a reflective element for changing the direction of view of the camera, and an objective lens assembly, and
a housing for said optical system, said housing arranged to locate the optical system in alignment with the camera of a portable programmable device
wherein the housing positions optical systems reflective element between the objective lens assembly and the camera.

58. A lens system as claimed in claim 57 wherein the optical system redirects the direction of view of the camera by a substantially 90 degree angle.

59. A lens system as claimed in claim 57 wherein the reflective element of the optical system is a mirror.

60. A lens system as claimed in claim 57 wherein the reflective element of the optical system is a prism.

61. A lens system as claimed in claim 57 wherein the housing is releasable attachable to the portable programmable device.

62. A lens system as claimed in claim 57 wherein the housing is formed by a case that grips all or part of the portable programmable device.

63. A lens system as claimed in claim 57 wherein the housing includes a snorkel lenses assembly adapted to allow rotation of the optical system.

64. A lens system as claimed in claim 57 which includes at least one light pipe, wherein the light pipe includes
a body which provides an optical waveguide, and
an inlet arranged to receive light into the body, and
at least one outlet arranged to emit light from the body.

65. A method of image capture and modification implemented through the execution of computer readable instructions configured to execute on a portable programmable device which includes a camera system, said camera system being associated with a removable lens system, the application including executable instructions arranged to execute the steps of
receiving an input image from the camera system captured using the lens system, and
applying at least one correction function to the input image, and
outputting at least one corrected image,
wherein said correction function is adapted to improve the quality of the image captured by the camera.

66. A method of image capture and modification as claimed in claim 65 which includes the additional preliminary step of identifying the portable programmable device and/or camera system.

67. A method of image capture and modification as claimed in claim 65 wherein said correction function is arranged to correct for the effects of optical deficiencies of the lens system.

68. A method of image capture and modification as claimed in claim 65 further characterised by the additional steps of
receiving at least one input orientation indication from one or more orientation sensors associated with the programmable device,
applying at least one translation function to an input image
outputting at least one corrected image
wherein an input parameter of said translation function is the orientation indication received from an orientation indication sensor.

69. A method of image capture and modification as claimed in claim 65 characterised by the additional steps of
receiving at least one input orientation indication from one or more orientation sensors associated with the programmable device,
applying at least one translation function to an input image
generating a cropped image by selecting a sub-region of a translated image
outputting said cropped image
wherein an input parameter of said translation function is the orientation indication received from an orientation indication sensor.

70. A method of image capture and modification as claimed in claim 68 wherein a translation function includes an image rotation function.

71. A method of image capture and modification as claimed in claim 65 wherein a correction function reduces the effect of optical aberrations associated with the lens system.

72. A method of image capture and modification as claimed in claim 65 wherein a correction function corrects for geometrical distortions associated with the lens system.

73. A computer readable medium bearing computer readable instructions for a portable programmable device, said instructions being arranged to execute on a portable programmable device which includes a camera system, said camera system being associated with a removable lens system, the instructions arranged to execute the steps of
receiving an input image from the camera system captured using the lens system, and
applying at least one correction function to the input image, and
outputting at least one corrected image,
wherein said correction function is adapted to improve the quality of the image captured by the camera.

74. A computer readable medium bearing computer readable instructions as claimed in claim 73 which includes the additional preliminary step of identifying the portable programmable device and/or camera system.

75. A computer readable medium bearing computer readable instructions as claimed in claim 73 which executes the additional steps of
receiving at least one input orientation indication from one or more orientation sensors associated with the programmable device,
applying at least one translation function to an input image
generating a cropped image by selecting a sub-region of a translated image
outputting said cropped image
wherein an input parameter of said translation function is the orientation indication received from an orientation indication sensor.
